(19) United States
(12) Patent Application Publication
(10) Pub. No.: US 2009/0141110 A1
(43) Pub. Date: Jun. 4, 2009

(54) INK-JET PRINTER USING PHASE-CHANGE INK FOR DIRECT ON PAPER PRINTING

(75) Inventors: David J. Gervasi, Pittsford, NY (US); Santokh S. Badesha, Pittsford, NY (US); James E. Williams, Penfield, NY (US); Paul J. McConville, Webster, NY (US)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Norwalk, CT (US)

(21) Appl. No.: 11/948,166

(22) Filed: Nov. 30, 2007

(51) Int. Cl. B41J 2/01

(52) U.S. Cl. 347/100; 347/102

(57) ABSTRACT

A printing apparatus, including a) a printing station with at least one printhead for applying phase-change ink to a substrate in a phase-change ink image, and b) an ink spreading station including a heated or unheated ink spreading member and a back-up pressure member in pressure contact with the ink spreading member, and wherein a nip is formed between the ink spreading member and the back-up pressure member for spreading the phase-change ink image on the substrate, wherein said substrate is passed through the nip, and wherein the pressure member includes i) a substrate, and ii) an outer coating having a polymer matrix with an oleophobic resin, a fluoropolymer lubricant, and a first additive.

### CROSS REFERENCE TO RELATED APPLICATIONS

Attention is directed to U.S. application Ser. No. ______ (Attorney Docket No. 20070152-US-NP), filed ______, entitled “Phase Change Ink Imaging Component Having Composite Outer Layer.”

### BACKGROUND

The present disclosure relates to ink-jet printing, particularly involving phase-change inks printing directly on a substrate, wherein the substrate can be a substantially continuous web or can be a substrate such as paper or cut paper. In embodiments, the printing apparatus includes an ink spreader station having a heated ink spreader member and a back-up pressure member. In embodiments, the pressure member of the ink spreader/pressure system includes a coating comprising an oleophobic resin, a fluoropolymer lubricant, and a first additive.

Ink jet printing involves ejecting ink droplets from orifices in a print head onto a receiving surface to form an image. The image is made up of a grid-like pattern of potential drop locations, commonly referred to as pixels. The resolution of the image is expressed by the number of ink drops or dots per inch (dpi), with common resolutions being 300 dpi and 600 dpi.

Ink-jet printing systems commonly use either a direct printing or offset printing architecture. In a typical direct printing system, ink is ejected from jets in the print head directly onto the final receiving web or substrate such as paper or cut paper. In an offset printing system, the image is formed on an intermediate transfer surface and subsequently transferred to the final receiving web. The intermediate transfer surface may take the form of a liquid layer that is applied to a support surface, such as a drum. The print head jets the ink onto the intermediate transfer surface to form an ink image thereon. Once the ink image has been fully deposited, the final receiving web is then brought into contact with the intermediate transfer surface and the ink image is transferred to the final receiving web.

U.S. Pat. No. 5,389,958, assigned to the assignee of the present application, is an example of an indirect or offset printing architecture that uses phase change ink. The ink is applied to an intermediate transfer surface in molten form, having been melted from its solid form. The ink image solidifies on the liquid intermediate transfer surface by cooling to a malleable solid intermediate state as the drum continues to rotate. When the imaging has been completed, a transfer roller is moved into contact with the drum to form a pressurized transfer nip between the roller and the curved surface of the intermediate transfer surface/drum. A final receiving web, such as a sheet of media, is then fed into the transfer nip and the ink image is transferred to the final receiving web.

U.S. Pat. Nos. 5,777,650; 6,494,570; and 6,113,231 show the application of pressure to ink-jet-printed images. U.S. Pat. Nos. 5,345,863; 5,406,315; 5,793,398; 6,361,230; and 6,485,140 describe continuous-web ink-jet printing systems.

It is desired to provide a pressure member for use with phase change ink printing machines, including duplex machines and direct on paper or direct on web machines, which has the ability to assist in the spreading of the direct on paper developed print without causing alteration to the previously printed ink which contacts the pressure roll during duplex printing. In particular, gloss alterations to the image that can be overall or patterned (ghosting) and ink offset to the pressure roll surface which can be re-deposited back onto the paper/web are improved. It is desired that the pressure member when heated is thermally stable when heated to the operating temperature, wear resistant, has consistent mechanical properties under high load, resists adhesion of ink, and is oleophobic.

### SUMMARY

Included herein, in embodiments, is a printing apparatus, including a) a printing station with at least one printhead for applying phase-change ink to a substrate in a phase-change ink image, and b) an ink spreading station including a heated ink spreading member and a back-up pressure member in pressure contact with the ink spreading member, and wherein a nip is formed between the ink spreading member and the back-up pressure member for spreading the phase-change ink image to the substrate, wherein said substrate is passed through the nip, and wherein the pressure member includes i) a substrate, and ii) an outer coating having a polymer matrix with an oleophobic resin, a fluoropolymer lubricant, and a first additive.

### BRIEF DESCRIPTION OF THE DRAWING

The above embodiments will become apparent as the following description proceeds upon reference to the drawings, which include the following figures:

FIG. 1 is a simplified elevational view of a direct-to-sheet, continuous-web, phase-change ink printer.

FIG. 2 is an enlarged view of an embodiment of a pressure drum having a substrate and an outer composite layer thereon.

FIG. 3 is an enlarged view of an embodiment of a pressure drum having a substrate, and optional intermediate layer, and an outer composite layer thereon.

FIG. 4 is graph showing improvement in duplex ghosting performance over baseline rollers.

FIG. 5 is a bar graph showing improvement in ghosting of rollers in both oil or oil-less configurations.

### DETAILED DESCRIPTION

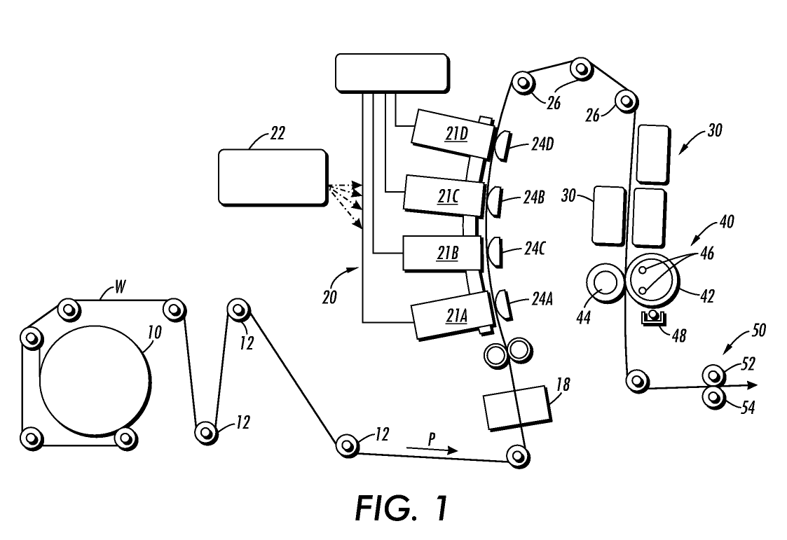

FIG. 1 is a simplified elevational view of a direct-to-sheet, continuous-web, phase-change ink printer. A very long (i.e., substantially continuous) web W of “substrate” (paper, plastic, or other printable material), supplied on a spool 10, is unwound as needed, propelled by a variety of motors, not shown. A set of rolls 12 controls the tension of the unwinding web as the web moves through a path.

Along the path there is provided a preheater 18, which brings the web to an initial predetermined temperature. The preheater 18 can rely on contact, radiant, conductive, or convective heat to bring the web W to a target preheat temperature, in one practical embodiment, of about 30° C. to about 70° C.

The web W moves through a printing station 20 including a series of printheads 21A, 21B, 21C, and 21D, each printhead effectively extending across the width of the web and being able to place ink of one primary color directly (i.e., without use of an intermediate or offset member) onto the moving web. As is generally familiar, each of the four primary-color images placed on overlapping areas on the web W combine to form a full-color image, based on the image data sent to each printhead through image path 22. In various possible embodiments, there may be provided multiple printheads for each primary color; the printheads can each be formed into a single linear array; the function of each color printhead can be divided among multiple distinct printheads located at different locations along the process direction; or the printheads or portions thereof can be mounted movably in a direction transverse to the process direction P, such as for spot-color applications.

The ink directed to web W in this embodiment is a “phase-change ink,” by which is meant that the ink is substantially solid at room temperature and substantially liquid when initially jetted onto the web W. Currently-common phase-change inks are typically heated to about 100° C. to 140° C., and thus in liquid phase, upon being jetted onto the web W. Generally speaking, the liquid ink cools down quickly upon hitting the web W.

Associated with each primary color printhead is a backing member 24A, 24B, 24C, 24D, typically in the form of a bar or roll, which is arranged substantially opposite the printhead on the other side of web W. Each backing member is used to position the web W so that the gap between the printhead and the sheet stays at a known, constant distance. Each backing member can be controlled to cause the adjacent portion of the web to reach a predetermined “ink-receiving” temperature, in one practical embodiment, of about 40° C. to about 60° C. In various possible embodiments, each backing member can include heating elements, cavities for the flow of liquids therethrough, etc.; alternatively, the “member” can be in the form of a flow of air or other gas against or near a portion of the web W. The combined actions of preheater 18 plus backing members 24 held to a particular target temperature effectively maintains the web W in the printing zone 20 in a predetermined temperature range of about 45° C. to 65° C.

As the partially-imaged web moves to receive inks of various colors throughout the printing station 20 it is required that the temperature of the web be maintained to within a given range. Ink is jetted at a temperature typically significantly higher than the receiving web's temperature and thus will heat the surrounding paper (or whatever substance the web W is made of). Therefore the members in contact with or near the web in zone 20 must be adjusted so that that the desired web temperature is maintained. For example, although the backing members will have an effect on the web temperature, the air temperature and air flow rate behind and in front of the web will also impact the web temperature and thus must be considered when controlling the web temperature, and thus the web temperature could be affected by utilizing air blowers or fans behind the web in printing station 20.

Thus, the web temperature is kept substantially uniform for the jetting of all inks from printheads in the printing zone 20. This uniformity is valuable for maintaining image quality, and particularly valuable for maintaining constant ink lateral spread (i.e., across the width of web W, such as perpendicular to process direction P) and constant ink penetration of the web. Depending on the thermal properties of the particular inks and the web, this web temperature uniformity may be achieved by preheating the web and using uncontrolled backer members, and/or by controlling the different backer members 24A, 24B, 24C, 24D to different temperatures to keep the substrate temperature substantially constant throughout the printing station. Temperature sensors (not shown) associated with the web W may be used with a control system to achieve this purpose, as well as systems for measuring or inferring (from the image data, for example) how much ink of a given primary color from a printhead is being applied to the web W at a given time. The various backer members can be controlled individually, using input data from the printhead adjacent thereto, as well as from other printheads in the printing station.

Following the printing zone 20 along the web path is a series of tension rolls 26, followed by one or more “midheaters” 30. The midheater 30 can use contact, radiant, conductive, and/or convective heat to bring the web W to the target temperature. The midheater 30 brings the ink placed on the web to a temperature suitable for desired properties when the ink on the web is sent through the ink spreader 40. In one embodiment, a useful range for a target temperature for the midheater is about 35° C. to about 80° C. The midheater 30 has the effect of equalizing the ink and substrate temperatures to within about 15° C. of each other. Lower ink temperature gives less line spread while higher ink temperature causes show-through (visibility of the image from the other side of the print). The midheater 30 adjusts substrate and ink temperatures to 0° C. to 20° C. above the temperature of the ink spreader, which will be described below.

Following the midheaters 30, along the path of web W, is an “ink spreader” 40, that applies a predetermined pressure, and in some implementations, heat, to the web W. The function of the ink spreader 40 is to take what are essentially isolated droplets of ink on web W and smear them out to make a continuous layer by pressure, and, in one embodiment, heat, so that spaces between adjacent drops are filled and image solids become uniform. In addition to spreading the ink, the ink spreader 40 may also improve image permanence by increasing ink layer cohesion and/or increasing the ink-web adhesion. The ink spreader 40 includes rolls, such as image-side roll 42 and pressure roll 44, that apply heat and pressure to the web W. Either roll can include heat elements such as 46 to bring the web W to a temperature in a range from about 35° C. to about 80° C.

In one practical embodiment, the roll temperature in the ink spreader 40 is maintained at about 55° C.; generally, a lower roll temperature gives less line spread while a higher temperature causes imperfections in the gloss. A roll temperature higher than about 57° C. causes ink to offset to the roll. In one practical embodiment, the nip pressure is set in a range of about 500 to about 2000 psi lbs/side. Lower nip pressure gives less line spread while higher may reduce pressure roll life.

The ink spreader 40 can also include a cleaning/oiling station 48 associated with image-side roll 42, suitable for cleaning and/or applying a layer of some lubricant or other material to the roll surface. Such a station coats the surface of the ink spreader roll with a lubricant such as amino silicone oil having viscosity of about 10-200 centipoises. Only small amounts of oil are required and the oil carry out by web W is only about 1-10 mg per A4 size page.

In one possible embodiment, the midheater 30 and ink spreader 40 can be combined within a single unit, with their respective functions occurring relative to the same portion of web W simultaneously.

Following the ink spreader 40, the printer in this embodiment includes a “glosser” 50, whose function is to change the gloss of the image (such a glosser can be considered an “option” in a practical implementation). The glosser 50 applies a predetermined combination of temperature and pressure, to obtain a desired amount of gloss on the ink that has just been spread by ink spreader 40. Additionally, the glosser roll surface may have a texture that the user desires to impress on the ink surface. The glosser 50 includes two rolls (image-side roll 52 and pressure roll 54) forming a nip through which the web W passes. In one practical embodiment, the controlled temperature at ink spreader 40 is about 35° C. to about 80° C. and the controlled temperature at glosser 50 is about 30° C. to about 70° C.

In each of the ink spreader 40 and glosser 50, the image side roll 42 or 52 contacting the inked side of the web is typically reasonably hard, such as being made of anodized aluminum. In each case, for the pressure roll 44 or 54, a relatively softer roll is used, with a durometer anywhere from about 50 D to about 65 D, with elastic modulii from about 65 MPa to about 115 MPa, and may include a thin elastomer overcoat. In various practical applications, elastomeric or rubbery pressure rolls of one or more layers, with effective elastic modulii from about 50 MPa to about 200 MPa, can be provided.

In a practical implementation, detailed and independent control of the respective temperatures associated with ink spreader 40 and glosser 50 (by a control system, not shown) enables gloss adjustment given particular operating conditions and desired print attributes.

Typical pressure against the web W for the roll pairs in each of the ink spreader 40 and glosser 50 is about 500 to about 2000 lbs/square inch. Adjustment of the pressure is advisable with ink formulations that are soft enough that high pressure would cause excessive spreading. It is also possible to provide an image-side roll 52 in glosser 50 with different surface textures so that, with higher temperature and pressure, texture can be impressed into the ink surface.

It will be recognized by those experienced in the art that the temperatures and pressures effective for spreading an ink of a given formulation will depend on the ink's specific thermal properties. If solvent- or water-based inks were used (i.e., not phase-change ink) in the given implementation, the ink would not necessarily land on the media as a drop but will generally spread out on its own and thus form a smooth layer, rendering, for example, the effect of the ink spreader 40 and other elements uncertain. Similarly, teachings involving placement of dye or inks on a substantially porous substrate such as woven or knit fabric are not necessarily applicable to the present disclosure, as, for instance, the use of an ink spreader such as 40 on cloth is likely to cause ink to be pushed through the cloth. For this and other reasons, many teachings relating to the application of solvent- or water-based inks to webs of various types are not applicable to the present discussion.

Following passage through the ink spreader 40 and glosser 50, the printed web can be imaged on the other side, and then cut into pages, such as for binding (not shown). Although printing on a substantially continuous web is shown in the embodiment, the claimed invention can be applied to a cut-sheet system as well. Different preheat, midheat and ink spreader temperature setpoints can be selected for different types and weights of web media.

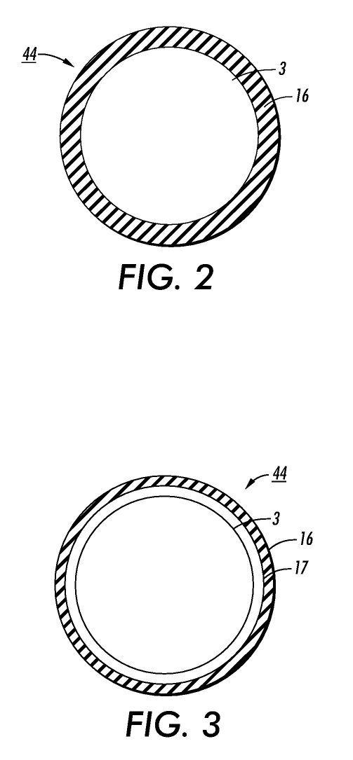

FIG. 2 demonstrates an embodiment herein, wherein pressure member 44 comprises substrate 15, having thereover outer coating 16.

FIG. 3 depicts another embodiment herein. FIG. 3 depicts a three-layer configuration for the pressure member comprising a substrate 3, intermediate layer 17 positioned on the substrate 3, and outer layer 16 positioned on the intermediate layer 17.

The pressure member 44 includes an outer layer 16 comprising a polymer matrix comprising oleophobic resin, a fluoropolymer lubricant, and an additive.

An “oleophobic” resin is defined herein as a resin that lacks affinity for oil. It is the opposite of oleophilic. The resin does not necessarily impart oloephobicity. It might, but the resulting composition must be oleophobic. The oleophobic resin can be a fluoropolymer, a polyamide, a polyimide, polyamide-imide, or the like, or mixtures thereof. In embodiments, the oleophobic resin is polyamide-imide, such as solubilized polyamide-imide.

The oleophobic resin is present in the imaging outer layer in an amount of from about 1 to about 95, or from about 50 to about 95, or from about 75 to about 90 percent by weight of total solids. Total solids as used herein refers to the total amount by weight of elastomer, additional additives (such as fillers and/or reinforcers), or like solid materials.

A “fluoropolymer lubricant” is defined herein as a polymeric material having less than about 50 percent fluorine by weight. Examples include fluorinated ethylene propylene (FEP), polytetrafluoroethylene (FEP), perfluoroalkoxy (PFA), and mixtures thereof. The fluoropolymer lubricant is present in the outer coating in an amount of from about 1 to about 50 percent, or from about 5 to about 30 percent, or from about 5 to about 15 percent by weight of total solids.

The additive can be a reinforcer and/or a filler. A “reinforcer” as used herein is defined as any additive that imparts unto a composite polymer system an enhanced physical or chemical property not inherently present in the system prior to its addition. A “filler” as used herein is defined as a solid particulate additive that imparts unto a composite polymer system an enhanced physical or chemical property not inherently present in the system prior to its addition.

Examples of reinforcers include those selected from carbon reinforcers, ceramics, polymers, and the like, and mixtures thereof. Examples of carbon reinforcers include carbon black (such as N-990 thermal black, N330 and N110 carbon blacks, and the like), graphite, fluorinated carbon (such as ACCUFLUOR® or CARBOFLUOR®), and the like, and mixtures thereof. Examples of ceramic materials include aluminum nitrate, boron nitride, silicates such as zirconium silicates, silica, titania, alumina, and the like, and mixtures thereof. Examples of polymer reinforcers include polytetrafluoroethylene powder, polypyrrole, polyacrylonitrile (for example, pyrolyzed polyacrylonitrile), polyaniline, polythiophenes, polyacetylene and the like, and mixtures thereof. In embodiments, the additive is a reinforcer and is carbon black.

The filler can be a metals, metal oxides, doped metal oxides and the like, and mixtures thereof, and can include titanium dioxide, tin (II) oxide, aluminum oxide, indium-tin oxide, magnesium oxide, copper oxide, iron oxide, silica or silicon oxide, and the like, and mixtures thereof.

The additive is present in the substrate, optional intermediate layer, and/or outer layer in an amount of from about 1 to about 50, or from about 5 to about 30, or from about 5 to about 20 percent by weight of total solids in the layer.

The polymer matrix comprising a resin, fluoropolymer lubricant and additive is present in the outer coating in an amount of from about 5 to about 95, or from about 10 to about 40 percent by weight of total solids.

Also included in the outer coating can be solvents and optional fillers other than the reinforcer and/or filler, and further the layer can include dispersion agents, co-solvents, surfactants, and the like.

In embodiments, the thickness of the outer imaging layer is from about 1 to about 200, or from about 25 to about 100, or from about 25 to about 75 microns.

The substrate, optional intermediate layer, and/or outer layer, in embodiments, may comprise additives, such as those just described, dispersed therein.

The pressure member substrate can comprise any material having suitable strength for use as a pressure member substrate. Examples of suitable materials for the substrate include metals, rubbers, fiberglass composites, and fabrics. Examples of metals include steel, aluminum, nickel, and their alloys, and like metals, and alloys of like metals. The thickness of the substrate can be set appropriate to the type of imaging member employed. In embodiments wherein the substrate is a belt, film, sheet or the like, the thickness can be from about 0.5 to about 500 mils, or from about 1 to about 250 mils. In embodiments wherein the substrate is in the form of a drum, the thickness can be from about 1/32 to about 1 inch, or from about 1/16 to about ⅝ inch.

Examples of suitable pressure substrates include a sheet, a film, a web, a foil, a strip, a coil, a cylinder, a drum, an endless strip, a circular disc, a belt including an endless belt, an endless seamed flexible belt, an endless seamless flexible belt, an endless belt having a puzzle cut seam, a weldable seam, and the like.

In an optional embodiment, an intermediate layer may be positioned between the pressure substrate and the outer layer. Materials suitable for use in the intermediate layer include silicone materials, fluoroelastomers, fluorosilicones, ethylene propylene diene rubbers, and the like, and mixtures thereof. In embodiments, the intermediate layer is conformable and is of a thickness of from about 2 to about 60 mils, or from about 4 to about 25 mils.

In embodiments, the water contact angle is above about 100° C. The coating has a high wear resistance of from about 1 million to about 3 million prints. Moreover, the coating has a smooth surface, having a surface roughness Ra of less than about 5 microns.

The process for producing the outer coating includes cleaning the roll with isopropyl alcohol (IPA), followed by masking the journal ends. The roll may be flow-coated with one pass of coating using program #8 on flow coater, 120 rpm/60 rps using small pump on Ismatek. This can be followed by flash for about 15 minutes, and followed by oven cure: 400 F, 15 minutes. The roll can be flipped on the coater to minimize end effects. The roll is then flow-coated with a second pass of coating, followed by air flash for about 15 minutes. This is followed by oven cure: 400 F, 15 minutes, and is then cooled.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

The following Examples further define and describe embodiments herein. Unless otherwise indicated, all parts and percentages are by weight.

### EXAMPLES

### Example 1

### Preparation of Pressure Roller

A steel core roll with additional layers of polyurethane was first cleaned with isopropyl alcohol (IPA), and the journal ends were masked. The roll was flow-coated with one pass of coating using program #8 on a flow coater. The coating flow rate was set to 120 rpm/60 rps using a small pump on an Ismatek pump system. This was followed by an ambient air flash for about 15 minutes, and followed by the following oven cure: 400° F., for about 15 minutes. The roll was reversed on the coater to minimize end effects. The roll was then flow-coated with a second pass of coating, followed by an ambient air flash for about 15 minutes. This was followed by an oven cure at 400° F. for about 15 minutes. The roll was then cooled in ambient laboratory conditions and prepared for machine testing by the addition of the appropriate bearings. The commercial formulation, XYLAN® 1404, manufactured by Whitford Worldwide Corporation was used as a control coating formulation for comparison to the uncoated roll. Subsequently, the 1404/D0842A was further modified by adding increasing amounts of either fluorinated ethylene propylene (FEP) or electrically conductive carbon black (CB) by the manufacturer. The rolls had an additional level of CB or FEP in the amount of about 5 to about 25 weight percent added to the original 1404/D0842A. The remaining coatings were combinations of the two additives within the compositional boundaries of the ‘four corners’ portion of the coating design.

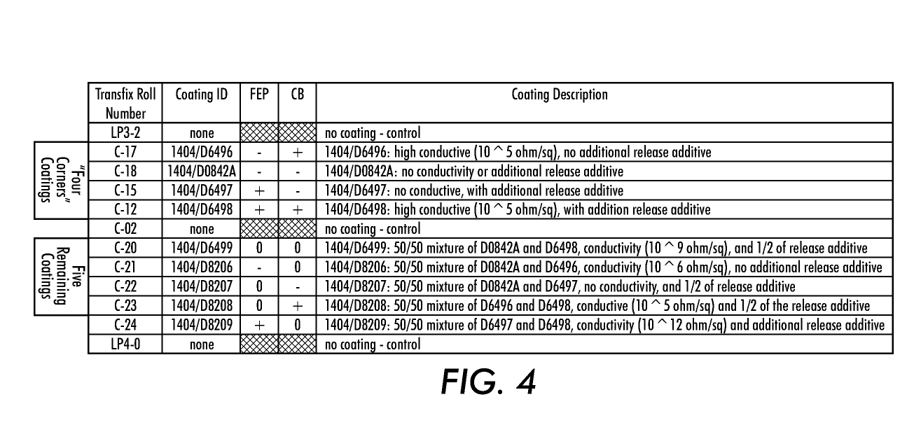

In the bar table shown in FIG. 4, a more complete description of the coating design is included, wherein the symbol “+” refers to a maximum amount of the additive and the symbol “−” refers to no additional additive. A number “0” corresponds to an amount of additive in between the “−” and “+” levels of the respective additive. The corresponding roll number for each formulation is also given in the bar table of FIG. 4.

### Example 2

### Comparative Testing for Duplex Ghosting

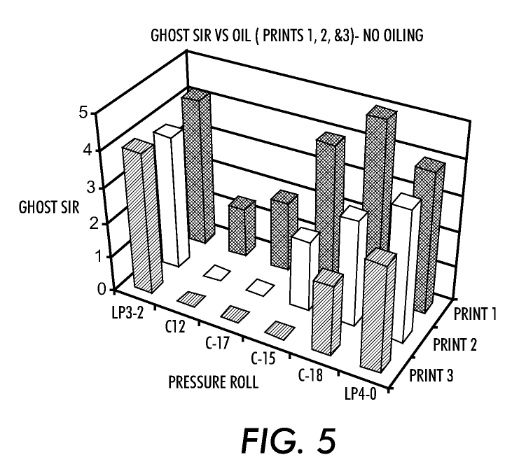

Several coated rolls that were coated according to the procedure described above in Example 1, and with specific embodiments of the coating described above were placed in a solid ink printer. Print quality performance was compared to that of several uncoated control rolls. The primary test response of interest was duplex ghosting and duplex gloss with “dry roll” conditions (no oil). The surface of the pressure roll can alter the gloss of the printed image when in contact in the ink spreader nip during duplex printing. The gloss is altered due to a change in the surface roughness caused by slight ink adhesion to the surface of the pressure member. Release oil on the pressure roll surface impacts the level of adhesion and thus the gloss level. Duplex ghosting is a gloss pattern artifact related to oil that is transferred to the pressure member surface from the ink resulting in areas on the pressure member that have less adhesion than other areas. The data collected from these tests are shown in the bar graph shown in FIG. 5. The control or uncoated pressure rollers are labeled LP3-2 and LP4-0. As shown in the bar graph of FIG. 5, the coated rolls C12, C16 and C17 provide superior performance over the control rolls. The rolls were measured by SIR (standard image reference). When a ‘real’ measurement is not available or does not exist, an SIR is used to comparatively rank order print quality with some attempt at calibration or standardization.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A printing apparatus, comprising:
a) a printing station including at least one printhead for applying phase-change ink to a substrate in a phase-change ink image, and
b) an ink spreading station comprising a heated or unheated ink spreading member and a back-up pressure member in pressure contact with said ink spreading member forming a nip between said ink spreading member and pressure member for spreading the phase-change ink image on the substrate, wherein said substrate is passed through said nip, and wherein said pressure member comprises i) a substrate, and ii) an outer coating comprising a polymer matrix comprising an oleophobic resin, a fluoropolymer lubricant, and a first additive.

2. The printing apparatus of claim 1, wherein said oleophobic resin is selected from the group consisting of polyamide-imide and fluoropolymer.

3. The printing apparatus of claim 1, wherein said fluoropolymer lubricant is selected from the group consisting of perfluoroalkoxy, tetrafluoroethylene, fluorinated ethylene propylene.

4. The printing apparatus of claim 1, wherein said first additive is a reinforcer selected from the group consisting of carbon reinforcers, ceramics, polymers, and mixtures thereof.

5. The printing apparatus of claim 4, wherein said reinforcer is a carbon reinforcer selected from the group consisting of carbon black, graphite, fluorinated carbon, and mixtures thereof.

6. The printing apparatus of claim 1, wherein said polymer matrix further comprises a second additive, wherein said second additive is a filler selected from the group consisting of a metals, metal oxides, doped metal oxides, and mixtures thereof.

7. The offset printing apparatus of claim 6, wherein said filler is selected from the group consisting of titanium dioxide, tin (II) oxide, aluminum oxide, indium-tin oxide, magnesium oxide, copper oxide, iron oxide, silica or silicon oxide, and mixtures thereof.

8. The printing apparatus of claim 1, wherein said phase change ink is solid at about 25° C.

9. The printing apparatus of claim 1, wherein the substrate is a substantially continuous web.

10. The printing apparatus of claim 1, wherein the substrate comprises paper.

11. The printing apparatus of claim 1, further comprising a preheater, disposed upstream from the ink spreading station, for bringing the substrate to a predetermined preheat temperature.

12. The printing apparatus of claim 1, wherein the pressure member includes a roll.
